(19) United States
(12) Patent Application Publication
(10) Pub. No.: US 2016/0040831 A1
(43) Pub. Date: Feb. 11, 2016

(54) ENERGY SAVING LIGHT BULB

(71) Applicant: HUNG CHIANG, PINGTUNG COUNTY (TW)

(72) Inventor: YEH-CHIN LIN, KAOHSIUNG CITY (TW)

(21) Appl. No.: 14/454,904

(22) Filed: Aug. 8, 2014

(51) Int. Cl. F21K 99/00; F21V 23/02; F21V 1/00; H05B 33/08

(52) U.S. Cl. CPC F21K 9/1355; H05B 33/0806; F21V 23/02; F21V 1/00

(57) ABSTRACT

An energy saving light bulb is revealed. It comprises a lampstand having a conductive connector, a pyramid assembly having a plurality of assembly surfaces, a plurality of LEDs and a plurality of rectifier diodes disposed on the plurality of assembly surfaces, a choke inductor having a first and second terminals disposed on the pyramid assembly, and a lampshade for assembling on the lampstand to shelter the pyramid assembly, the plurality of LEDs, the plurality of rectifier diodes and the choke inductor, wherein the first and second terminals connect to the plurality of LEDs, the plurality of rectifier diodes and the conductive connector of the lampstand.

### BACKGROUND OF THE INVENTION

1. Field of the Invention

The present invention relates to an energy saving light bulb with a low amount of heat released, an improved electrical efficiency and adjustable brightness and power consumption.

2. Description of Related Art

As shown in FIG. 3, a conventional high power LED bulb (7) mainly utilizes a low voltage LED (71) for generating a high power. However, the relatively increased current due to low voltage causes an extremely high temperature of the LED (71) at the time of light emission. To prevent components of the LED bulb (7) from burning out, a lampstand (72) of the LED bulb (7) is provided with a plurality of heat dissipation fins (721), leading to an increased manufacturing cost. In addition, because the plurality of heat dissipation fins (721) only has a limited capacity of heat dissipation, it cannot solve a problem of overheating.

Besides, the conventional LED bulb (7) usually actuates the LED (71) by an electronic transformer (73) comprising a plurality of electronic components (731). The electronic transformer (73) is expensive and also generates a lot of waste heat during actuation, so the LED bulb (7) is prone to burning out due to an increased overall temperature of the LED bulb (7). Moreover, the plurality of electronic components (731) of the electronic transformer (73) containing many heavy metals may cause pollution and damage to the environment.

### SUMMARY OF THE INVENTION

In view of the above-mentioned problems, the object of the present invention is to provide an energy saving light bulb with a low amount of heat released, an improved electrical efficiency and adjustable brightness and power consumption.

Disclosed herein is an energy saving light bulb, comprising a lampstand having a conductive connector; a pyramid assembly having a plurality of assembly surfaces; a plurality of LEDs disposed on the plurality of assembly surfaces; a plurality of rectifier diodes disposed on the plurality of assembly surfaces; a choke inductor having a first terminal and a second terminal disposed on the pyramid assembly for current input and current output, wherein the first terminal connects to the plurality of LEDs and the plurality of rectifier diodes by a wire, and the second terminal connects to the conductive connector of the lampstand by a wire; and a lampshade for assembling on the lampstand to shelter the pyramid assembly, the plurality of LEDs, the plurality of rectifier diodes and the choke inductor.

Accordingly, the pyramid assembly increases an emission angle, and a high-voltage and low-current LED module constituted by the plurality of LEDs in series and in parallel to reduce the current, thereby decreasing heat generation. Furthermore, the choke inductor can adjust the current to improve electrical efficiency, save energy, and reduce heat generation during actuation of the LED module without setting heat dissipation fins, which not only prevent components from burning out due to overheating but also save much manufacturing cost.

### BRIEF DESCRIPTION OF THE DRAWINGS

FIG. 1 is a stereogram showing an energy saving light bulb according to the present invention;

FIG. 2 is a cross-sectional view showing an energy saving light bulb according to the present invention;

FIG. 3 is a cross-sectional view showing a conventional high power LED bulb.

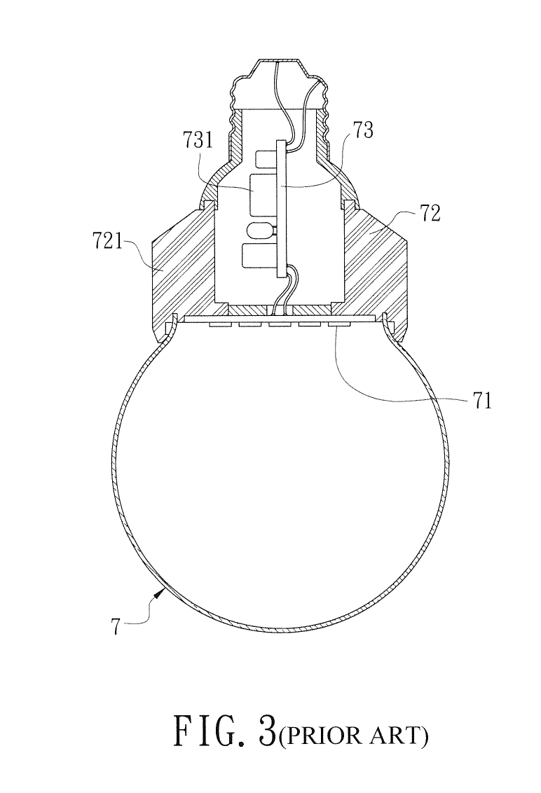

### DETAILED DESCRIPTION OF THE PREFERRED EMBODIMENT

Hereinafter, an exemplary embodiment of the present invention will be described in detail with reference to the accompanying drawings.

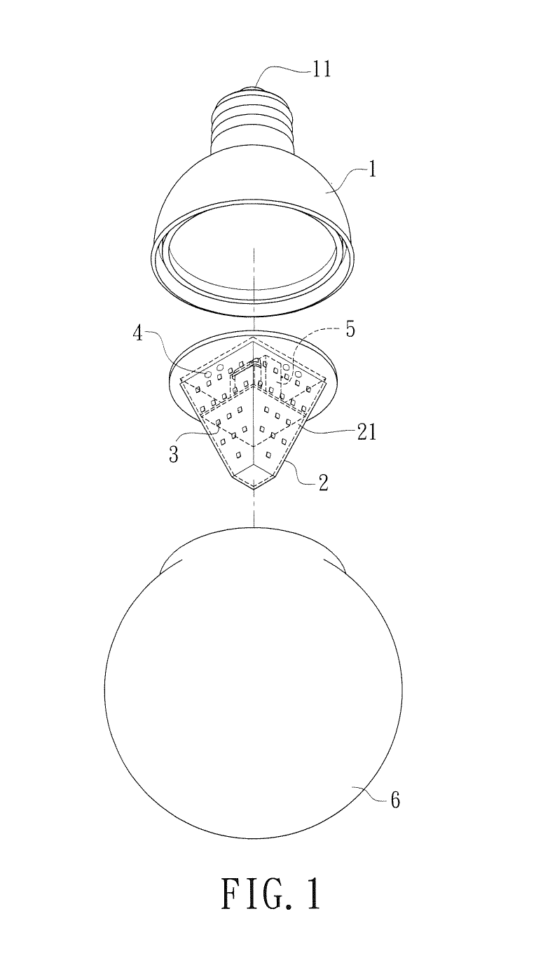

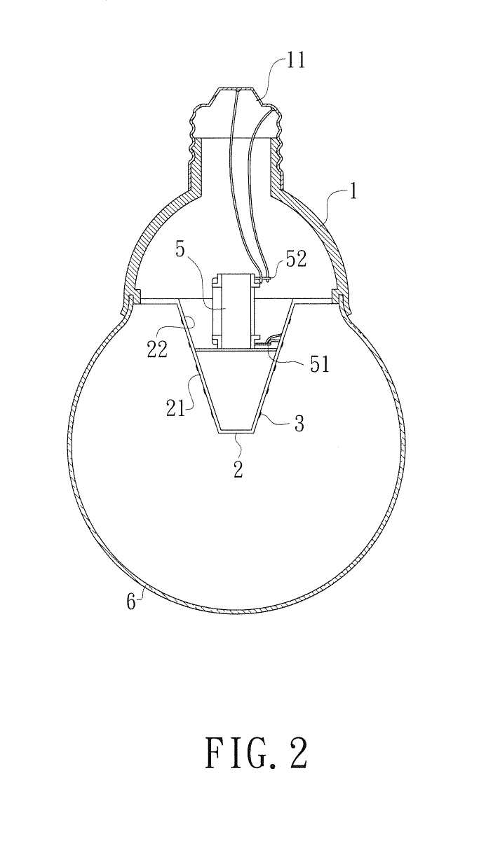

First, a stereogram and a cross-sectional view showing an energy saving light bulb according to the present invention are revealed in FIG. 1 and FIG. 2. An energy saving light bulb, comprising:
a lampstand (1) having a conductive connector (11);
a pyramid assembly (2) having a plurality of assembly surfaces (21) and an accommodating space (22);
a plurality of LEDs (3) disposed on the plurality of assembly surfaces (21) of the pyramid assembly (2), wherein the plurality of LEDs (3) constitutes a high-voltage and low-current LED module (a.k.a. HV LED) in series and in parallel;
a plurality of rectifier diodes (4) disposed on the plurality of assembly surfaces (21) of the pyramid assembly (2);
a choke inductor (5) having a first terminal (51) and a second terminal (52) disposed in the accommodating space (22) of the pyramid assembly (2) for current input and current output, wherein the first terminal (51) connects to the plurality of LEDs (3) and the plurality of rectifier diodes (4) by a wire, and the second terminal (52) connects to the conductive connector (11) of the lampstand (1) by a wire; and
a lampshade (6) for assembling on the lampstand (1) to shelter the pyramid assembly (2), the plurality of LEDs (3), the plurality of rectifier diodes (4) and the choke inductor (5).

In use of the energy saving light bulb, the conductive connector (11) of the lampstand (1) connects to a socket of a power source, allowing an output current to flow through the conductive connector (11) and into the second terminal (52) of the choke inductor (5) connecting to the conductive connector (11), allowing the energy saving light bulb to light up at night or in the dark. Moreover, the choke inductor (5) can adjust the voltage across an electronic circuit to maintain a constant electric current and output a power source suitable for use by the LEDs (3) and the rectifier diodes (4) on the pyramid assembly (2). Then the current flows into a LED module constituted by the plurality of LEDs (3) from the first terminal (51) of the choke inductor (5), allowing the LED module to emit light. Because the plurality of LEDs (3) is disposed on the plurality of the assembly surfaces (21) of the assembly surfaces (21), light can be emitted toward various directions, so as to increase light uniformity and illumination area of a LED bulb.

Accordingly, the current flowing through and regulated by the choke inductor (5) can improve electrical efficiency and extend the life of the LED module. In addition, the plurality of LEDs (3) constitutes a high-voltage and low-current LED module (a.k.a. HV LED) in series and in parallel, so heat generated during actuation of the LED module can be decreased without setting heat dissipation fins on the lampstand (1), which prevents components in the bulb from burning out due to overheating and lowers manufacturing cost of the lampstand (1). Furthermore, the energy saving light bulb of the present invention utilizes the choke inductor (5) consisted by electromagnetic steel sheets and coils instead of an electronic transformer for actuating the LEDs (3) to emit light, which saves much manufacturing cost, decreases a large amount of heat released during actuation of the choke inductor (5), extends the life of the LED module, and prevents heavy metal pollution.

In the foregoing description, the energy saving light bulb of the present invention can further has an adjustable resistor on an outside of the lampstand (1). The adjustable resistor connects to the choke inductor (5) by a wire and has a regulator so that resistance of the adjustable resistor can be adjusted by the regulator, thereby altering the voltage of the choke inductor (5) and changing the current flowing into the LEDs (3) by the choke inductor (5). Accordingly, the energy saving light bulb has an improved electrical efficiency and adjustable brightness and power consumption.

According to the above description, in comparison with the traditional technique, an energy saving light bulb according to the present invention has the advantages as following:
1. The energy saving light bulb constitutes a high-voltage and low-current LED module in series and in parallel and drives the

LEDs to emit light by the choke inductor so that heat generated during actuation of the LED module can be decreased. Therefore, the present invention prevents components in the bulb from burning out due to overheating and extends the life of the LED module.
2. The energy saving light bulb constitutes a high-voltage and low-current LED module in series and in parallel and utilizes the choke inductor to decrease heat released without setting complicated heat dissipation fins, which not only saves much manufacturing cost but also prevents heavy metal pollution by replacing an electronic transformer with the choke inductor.

What is claimed is:

1. An energy saving light bulb, comprising:
a lampstand having a conductive connector;
a pyramid assembly having a plurality of assembly surfaces;
a plurality of LEDs disposed on the plurality of assembly surfaces of the pyramid assembly;
a plurality of rectifier diodes disposed on the plurality of assembly surfaces of the pyramid assembly;
a choke inductor having a first terminal and a second terminal disposed on the pyramid assembly for current input and current output, wherein the first terminal connects to the plurality of LEDs and the plurality of rectifier diodes by a wire, and the second terminal connects to the conductive connector of the lampstand by a wire; and
a lampshade for assembling on the lampstand to shelter the pyramid assembly, the plurality of LEDs, the plurality of rectifier diodes and the choke inductor.

2. The energy saving light bulb as claimed in claim 1, wherein the pyramid assembly is shaped as a polygonal truncated cone and has the plurality of assembly surfaces each connecting with the plurality of LEDs and the plurality of rectifier diodes thereon.

3. The energy saving light bulb as claimed in claim 1, wherein the pyramid assembly further has an accommodating space for accommodating the choke inductor.

4. The energy saving light bulb as claimed in claim 1, wherein the energy saving light bulb further has an adjustable resistor having a regulator outside the lampstand and connecting to the choke inductor by a wire.

5. The energy saving light bulb as claimed in claim 1, wherein the plurality of LEDs constitutes a high-voltage and low-current LED module in series and in parallel.
